(19) United States
(12) Patent Application Publication
(10) Pub. No.: US 2026/0219072 A1
(43) Pub. Date: Jul. 30, 2026

(54) MODULAR ADAPTIVE MAGNETIC NAVIGATION

(71) Applicant: SB Technology, Inc., Palo Alto, CA (US)

(72) Inventors: Patrick L. Neary, Hyde Park, UT (US); Jonathan Ouellet, Hyde Park, UT (US); Kimberly Moore, Palo Alto, CA (US)

(21) Appl. No.: 19/036,958

(22) Filed: Jan. 24, 2025

(51) Int. Cl. G01C 25/00; G01C 21/08; G01C 21/20

(52) U.S. Cl. CPC G01C 25/00; G01C 21/08; G01C 21/20; G05D 1/243; G08G 5/50; B60W 2420/50; G05D 2101/15

(57) ABSTRACT

A magnetic navigation system utilizes a modular adaptive compensation pipeline to compensate or calibrate for various platform effects to which a vehicle is subjected. A denoising monitor detects noise characteristics in magnetic field data collected from one or more magnetometers of the vehicle and selectively activates one or more noise removal modules to remove noise from the magnetic field data, and a maneuver module detects a current state of the vehicle and selectively activates one or more maneuver modules to calibrate the magnetic field data for platform orientation effects.

### BACKGROUND

Various technologies exist for geolocating a vehicle within its environment and assisting with its navigation. For example, the Global Positioning System (GPS), similar to other existing global satellite-based radio navigation systems, is capable of providing a vehicle having a suitably-equipped GPS receiver with geolocation and time information any time the GPS receiver has an unobstructed line of sight to four or more GPS satellites. However, GPS satellite signals are low power signals that are susceptible to interference, and in some instances, intentional jamming, so the ability of a vehicle to determine its location using GPS is not always guaranteed.

Inertial navigation systems (INSs) have also been used for vehicle geolocation and navigation. Inertial navigation systems utilize motion and rotation sensors such as accelerometers and gyroscopes, and in some instances, other sensors such as altimeters, magnetometers, etc. to continuously track the position, orientation, and velocity of a vehicle relative to a last known position. Inertial navigation systems, however, are generally susceptible to drift over time, as smaller errors accumulate as the amount of time since the last known position was established increases. For this reason, inertial navigation systems and GPS systems are often used in combination with one another, with inertial navigation systems tracking the movement of a vehicle in parallel with a GPS system, and in some instances, periodically updating their last known positions using GPS data, such that geolocation of the vehicle can still be performed to some extent even if GPS data is temporarily not available.

Another technical approach, referred to herein as magnetic navigation (MagNav) has the potential to address many of the shortcomings of both GPS and inertial navigation systems, and relies on anomalies in the magnetic field of the Earth to assist with geolocation and navigation. While the dominant component of the Earth's magnetic field is relatively static, the magnetic field also includes temporal variations (i.e., variations that occur over time, but that are generally measurable) as well as geographical variations, which are generally referred to as magnetic anomalies. Magnetic anomalies are generally based on the underlying geology of the Earth, i.e., variations in chemistry and/or magnetism of the rocks in the Earth's lithosphere, which effectively define a magnetic anomaly “map” of the Earth that can be used to geolocate a vehicle incorporating one or more on-board magnetometers.

A substantial challenge associated with magnetic navigation, however, is a result of the effects of the vehicle itself on the magnetic signals sensed by the vehicle's magnetometers, which may generally be referred to herein as platform effects. For a vehicle such as an aircraft, for example, the structure of the aircraft may distort the Earth's anomaly field proximate the magnetometers, and furthermore electronics on-board the aircraft, particularly some types of communication equipment, may generate magnetic noise that may be sensed by the on-board magnetometers. Moreover, the orientation of the aircraft relative to the magnetic field, e.g., as may differ based on various maneuvers performed by the aircraft (e.g., ascents, descents, turns, etc.) may also impact the magnetic signals sensed by the on-board magnetometers. Due to the dynamic nature of aircraft travel and operation, these various platform effects are generally not static, and can vary substantially during the operation of the aircraft.

In some instances, the overall magnitude of platform effects can even exceed the magnitude of the magnetic anomalies used for geolocation and navigation, and as such, compensation or calibration for these platform effects is generally required in order to accurately geolocate a vehicle. Conventional approaches to platform effect compensation or calibration, however, have generally been global in nature and have attempted to compensate for all platform effects collectively. Moreover, conventional approaches have generally been platform-specific, such that a compensation or calibration algorithm that applies to one particular vehicle may not be usable for other vehicles, or may not even be usable for the same vehicle if the vehicle has been modified (e.g., as a result of installing new or different sources of magnetic noise).

Therefore, a continuing need exists in the art for an improved manner of compensating or calibrating for platform effects in association with magnetic navigation.

### SUMMARY

The present disclosure is related in part to a magnetic navigation system that utilizes a modular adaptive compensation pipeline to compensate or calibrate for various platform effects to which a vehicle is subjected. A denoising monitor detects noise characteristics in magnetic field data collected from one or more magnetometers of the vehicle and selectively activates one or more noise removal modules to remove noise from the magnetic field data, and a maneuver module detects a current state of the vehicle and selectively activates one or more maneuver modules to calibrate the magnetic field data for platform orientation effects.

Therefore, consistent with one aspect of the invention, a method of magnetic navigation may include receiving sensor data, the sensor data including magnetic field data collected from one or more magnetometers of a vehicle, in a first monitor, detecting a noise characteristic in the received sensor data, and in response to detecting the noise characteristic, selectively activating at least one of a plurality of noise removal modules in a denoising pipeline, in each selectively activated noise removal module in the denoising pipeline, removing noise associated with the detected noise characteristic from the magnetic field data, in a second monitor, detecting a current state of the vehicle from the received sensor data, and in response to detecting the current state of the vehicle, selectively activating at least one of a plurality of maneuver modules in a state calibration pipeline, in each selectively activated maneuver module in the state calibration pipeline, calibrating the magnetic field data to correct for platform orientation effects, where removing noise associated with the detected noise characteristic and calibrating the magnetic field data to correct for platform orientation effects generates denoised and calibrated magnetic field data from the received sensor data, and estimating a position of the vehicle using the denoised and calibrated magnetic field data.

In some implementations, estimating the position of the vehicle includes comparing the denoised and calibrated magnetic field data to reference magnetic field data from a magnetic anomaly map. Also, in some implementations, the first monitor includes a square wave denoising monitor configured to detect a square wave noise signal in the received sensor data, and the plurality of noise removal modules includes a plurality of square wave denoising modules, and each of the plurality of square wave denoising modules is configured to remove square wave noise signals from the magnetic field at a predetermined frequency or within a predetermined frequency range. Further, in some implementations, the first monitor includes a frequency spectrum denoising monitor configured to analyze a frequency spectrum from the received sensor data to identify a noise source in the magnetic field data, and the plurality of noise removal modules includes a plurality of notch filter modules, each of the plurality of notch filter modules is configured to filter out noise sources in the magnetic field data at a predetermined frequency or within a predetermined frequency range.

In some implementations, the plurality of noise removal modules includes a sinusoidal wave filter module, a high pass filter module, a low pass filter module, a bandpass filter module, a DC offset removal module and/or a Tolles-Lawson module. In addition, in some implementations, the noise characteristic includes a square wave, a frequency spectrum peak, a sinusoidal wave, or a DC offset. In some implementations, the noise characteristic is a first noise characteristic and the plurality of noise removal modules is a first plurality of noise removal modules, the method further including in a third monitor, detecting a second noise characteristic in the received sensor data, and in response to detecting the second noise characteristic, selectively activating at least one of a second plurality of noise removal modules in the denoising pipeline, and in each selectively activated noise removal module in the second plurality of noise removal modules in the denoising pipeline, removing noise associated with the second detected noise characteristic from the magnetic field data.

In addition, in some implementations, the second monitor includes a maneuver monitor. Moreover, in some implementations, the plurality of maneuver modules includes an ascent module configured to calibrate for platform orientation effects while the vehicle is ascending, a descent module configured to calibrate for platform orientation effects while the vehicle is descending, a turning module configured to calibrate for platform orientation effects while the vehicle is turning, and/or an evasion module configured to calibrate for platform orientation effects while the vehicle is undergoing evasive maneuvers.

In some implementations, at least a subset of the plurality of maneuver modules include machine learning models, and the method further includes, in a model update monitor, triggering an update of at least one of plurality of maneuver modules. Moreover, in some implementations, the model update monitor includes a machine learning model configured to output update classifications for the plurality of maneuver modules, and the machine learning module is trained using a plurality of training instances mapping sensor data to updated maneuver modules.

In some implementations, the sensor data further includes altimeter data, barometer data, accelerometer data, tachometer data, magnetic compass data, airspeed indicator data, and/or gyroscope data. In addition, in some implementations, the first monitor includes a machine learning model configured to output activation classifications for the plurality of noise removal modules, and the machine learning module is trained using a plurality of training instances mapping sensor data to activated noise removal modules. In some implementations, the second monitor includes a machine learning model configured to output activation classifications for the plurality of maneuver modules, and the machine learning module is trained using a plurality of training instances mapping sensor data to activated maneuver modules.

Moreover, in some implementations, a first noise removal module of the plurality of noise removal modules includes a machine learning model configured to denoise magnetic field data from the received sensor data, and the machine learning module is trained using a plurality of training instances mapping sensor data to denoised magnetic field data. Also, in some implementations, a first maneuver module of the plurality of maneuver modules includes a machine learning model configured to calibrate the magnetic field data to correct for platform orientation effects, and the machine learning module is trained using a plurality of training instances mapping sensor data to calibrated magnetic field data.

In some implementations, at least one of the first monitor, the second monitor, a first noise removal module of the plurality of noise removal modules, and a first maneuver module of the plurality of noise removal modules includes a machine learning model, and the machine learning module is trained using a plurality of platform-independent training instances. In addition, in some implementations, the machine learning model is further trained using a plurality of platform-specific training instances. Also, in some implementations, at least one of the first monitor, the second monitor, a first noise removal module of the plurality of noise removal modules, and a first maneuver module of the plurality of noise removal modules includes a machine learning model, and the machine learning model outputs explanation and/or fault data in addition to compensated sensor data and/or module activation data.

Consistent with another aspect of the invention, a magnetic navigation system may include one or more processors and memory operably coupled with the one or more processors, and where the memory stores instructions that, in response to execution of the instructions by one or more processors, cause the one or more processors to perform a method of magnetic navigation that includes receiving sensor data, the sensor data including magnetic field data collected from one or more magnetometers of a vehicle, in a first monitor, detecting a noise characteristic in the received sensor data, and in response to detecting the noise characteristic, selectively activating at least one of a plurality of noise removal modules in a denoising pipeline, in each selectively activated noise removal module in the denoising pipeline, removing noise associated with the detected noise characteristic from the magnetic field data, in a second monitor, detecting a current state of the vehicle from the received sensor data, and in response to detecting the current state of the vehicle, selectively activating at least one of a plurality of maneuver modules in a state calibration pipeline, in each selectively activated maneuver module in the state calibration pipeline, calibrating the magnetic field data to correct for platform orientation effects, where removing noise associated with the detected noise characteristic and calibrating the magnetic field data to correct for platform orientation effects generates denoised and calibrated magnetic field data from the received sensor data, and estimating a position of the vehicle using the denoised and calibrated magnetic field data.

Consistent with another aspect of the invention, a non-transitory computer readable storage medium may store computer instructions executable by one or more processors to perform a method of magnetic navigation that includes receiving sensor data, the sensor data including magnetic field data collected from one or more magnetometers of a vehicle, in a first monitor, detecting a noise characteristic in the received sensor data, and in response to detecting the noise characteristic, selectively activating at least one of a plurality of noise removal modules in a denoising pipeline, in each selectively activated noise removal module in the denoising pipeline, removing noise associated with the detected noise characteristic from the magnetic field data, in a second monitor, detecting a current state of the vehicle from the received sensor data, and in response to detecting the current state of the vehicle, selectively activating at least one of a plurality of maneuver modules in a state calibration pipeline, in each selectively activated maneuver module in the state calibration pipeline, calibrating the magnetic field data to correct for platform orientation effects, where removing noise associated with the detected noise characteristic and calibrating the magnetic field data to correct for platform orientation effects generates denoised and calibrated magnetic field data from the received sensor data, and estimating a position of the vehicle using the denoised and calibrated magnetic field data.

Consistent with another aspect of the invention, a method of magnetic navigation may include receiving sensor data, the sensor data including magnetic field data collected from one or more magnetometers of a vehicle, in a denoising monitor, detecting a noise characteristic in the received sensor data, and in response to detecting the noise characteristic, selectively activating at least one of a plurality of noise removal modules in a denoising pipeline, in each selectively activated noise removal module in the denoising pipeline, removing noise associated with the detected noise characteristic from the magnetic field data, where removing noise associated with the detected noise characteristic generates denoised magnetic field data from the received sensor data, and estimating a position of the vehicle using the denoised magnetic field data.

Consistent with another aspect of the invention, a method of magnetic navigation may include receiving sensor data, the sensor data including magnetic field data collected from one or more magnetometers of a vehicle, in a maneuver monitor, detecting a current state of the vehicle from the received sensor data, and in response to detecting the current state of the vehicle, selectively activating at least one of a plurality of maneuver modules in a state calibration pipeline, in each selectively activated maneuver module in the state calibration pipeline, calibrating the magnetic field data to correct for platform orientation effects, where calibrating the magnetic field data to correct for platform orientation effects generates calibrated magnetic field data from the received sensor data, and estimating a position of the vehicle using the calibrated magnetic field data.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example implementations of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 illustrates an example hardware and software environment for a vehicle utilizing a magnetic navigation system consistent with some implementations.

FIG. 2 is a block diagram illustrating one example implementation of a modular adaptive calibration pipeline capable of being utilized in the magnetic navigation system of FIG. 1.

FIG. 3 is a block diagram illustrating one type of denoising module capable of being used in the modular adaptive calibration pipeline of FIG. 2.

FIG. 4 is a block diagram illustrating another type of denoising module capable of being used in the modular adaptive calibration pipeline of FIG. 2.

FIG. 5 is a block diagram illustrating a training system for training a maneuver monitor machine learning model used in the modular adaptive calibration pipeline of FIG. 2.

FIG. 6 is a block diagram illustrating a training system for training a maneuver module machine learning model used in the modular adaptive calibration pipeline of FIG. 2.

FIG. 7 is a block diagram illustrating a training system for training a model update monitor machine learning model used in the modular adaptive calibration pipeline of FIG. 2.

FIG. 8 is a block diagram illustrating a training system for training a noise removal module monitor machine learning model used in the modular adaptive calibration pipeline of FIG. 2.

FIG. 9 is a block diagram illustrating a training system for training a noise removal module machine learning model used in the modular adaptive calibration pipeline of FIG. 2.

FIG. 10 is a block diagram illustrating a pipeline module machine learning model capable of outputting explanation and/or fault data, and capable of being used in the modular adaptive calibration pipeline of FIG. 2.

FIG. 11 is a flowchart illustrating an example operational sequence for determining a vehicle position using a modular adaptive magnetic navigation system consistent with some implementations.

### DETAILED DESCRIPTION

The various implementations discussed hereinafter are generally directed in part to a modular adaptive magnetic navigation system that utilizes a modular adaptive compensation pipeline to compensate or calibrate for various platform effects. Prior to a discussion of these implementations, however, an example hardware and software environment within which the various techniques disclosed herein may be implemented will be discussed.

### Hardware and Software Environment

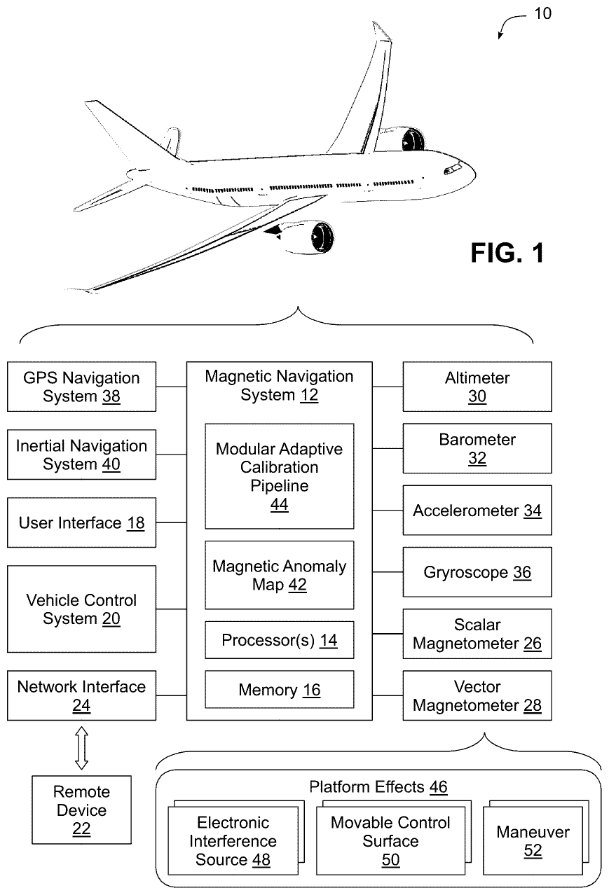

Turning to the Drawings, wherein like numbers denote like parts throughout the several views, FIG. 1 illustrates an example vehicle 10 within which the various techniques disclosed herein may be implemented. Vehicle 10, for example, is shown as a commercial aircraft; however, it will be appreciated that the principles of the invention may apply to a wide variety of other different types of vehicles, including vehicles capable of transporting people and/or cargo, and capable of traveling by land, by sea, by air, underground, undersea and/or in space, and regardless of whether operated autonomously, semi-autonomously, remote controlled, or by human operators.

Vehicle 10 includes a magnetic navigation system 12 that includes one or more processors 14 and one or more memories 16, and that is capable of interacting with various geolocation consumers, e.g., a user interface 18 such as a status display capable of displaying geolocation, map and/or navigation data and/or a vehicle control system 20 capable of using geolocation data in connection with operating the vehicle, in an autonomous, semi-autonomous, remote controlled, or human-assisted manner. A consumer in some implementations may also be remote from vehicle 10, e.g., a remote device 22 such as a cloud service, user device, mobile device, etc. interfaced to magnetic navigation system 12 via a network interface 24. Additional consumers include, for example, consumers that ingest raw sensor data, lightly processed data, calibrated sensor data, reference magnetic field data (e.g., map data), position/navigation/timing (PNT) data, etc. Network interface 24 may be suitable for communicating with one or more networks (e.g., a LAN, a WAN, a wireless network, and/or the Internet, among others) to permit the communication of information with other vehicles, computers, and/or electronic devices, including, for example, a central service, such as a cloud service.

Magnetic navigation system 12 is also interfaced with a number of sensors 26-36 capable of being used to determine a position of vehicle 10. For example, system 12 may access one or more magnetometers, e.g., one or more scalar magnetometers 26 and one or more vector magnetometers, to obtain magnetic field data in the vicinity of vehicle 10, which may be compared against a magnetic anomaly map to geolocate the vehicle. Furthermore, various additional sensors, e.g., one or more altimeters 30, barometers 32, accelerometers 34, and/or gyroscopes 36 may be used to supplement the magnetic field data in connection with geolocating the vehicle. It will be appreciated that for various vehicle types, different types of additional sensors may be useful in geolocating the vehicle, and as such, not all of sensors 26-36 may be used in some vehicle designs. Moreover, multiple instances of different sensors 26-36 (e.g., having differing capabilities and/or differing fields of view) may be used in some vehicle designs.

In addition, in some implementations, magnetic navigation system 12 may be interfaced with one or more other navigation and/or geolocation systems, e.g., a GPS navigation system 38 and/or an inertial navigation system (INS) 40. In some implementations, for example, various sensors utilized by magnetic navigation system 12 may be implemented within GPS navigation system 38 or INS 40 (e.g., where accelerometer and gyroscope data is provided to magnetic navigation system 12 by INS 40), while in other implementations, separate sensors may be used. Moreover, each of magnetic navigation system 12, GPS navigation system 38 and INS 40 may provide geolocation data to other systems and/or receive geolocation data from other systems for the purposes of redundancy and fault tolerance. For example, geolocation data generated by magnetic navigation system 12 may be provided to INS 40 to periodically update the last known position utilized by the INS.

Magnetic navigation system 12 operates, in part, by determining a position of vehicle 10 based upon magnetic field data collected using magnetometers 26, 28 and compared against a magnetic anomaly map 42 for the environment surrounding the vehicle. In addition, as will be discussed in greater detail below, magnetic navigation system 12 also includes a modular adaptive calibration pipeline 44 that calibrates the collected magnetic field data for various platform effects illustrated at 46 in FIG. 1. While the types of platform effects that may affect vehicle 10 may vary considerably based on the type of vehicle and components installed thereon, for an airborne vehicle such as a fixed wing aircraft, typical platform effects include, for example, various electronic interference sources 48 such as strobe lights, communication equipment, avionics, propulsion systems, etc.; movable control surfaces 50 such as ailerons, flaps, elevators, rudders, stabilizers, etc.; and various maneuvers capable of being performed by a vehicle, e.g., climbs or ascents, descents, turns, rolls, takeoffs, landings, etc., as well as operation at different altitudes, which can distort magnetometer readings due to the vehicle's orientation relative to the Earth's magnetic field.

In general, an innumerable number of different architectures, including various combinations of software, hardware, circuit logic, sensors, networks, etc. may be used to implement the various components illustrated in FIG. 1. Each processor may be implemented, for example, as a microprocessor and each memory may represent the random access memory (RAM) devices comprising a main storage, as well as any supplemental levels of memory, e.g., cache memories, non-volatile or backup memories (e.g., programmable or flash memories), read-only memories, etc. In addition, each memory may be considered to include memory storage physically located elsewhere in vehicle 10, e.g., any cache memory in a processor, as well as any storage capacity used as a virtual memory, e.g., as stored on a mass storage device or on another computer or controller. In addition, for additional storage, vehicle 10 may also include one or more mass storage devices, e.g., a floppy or other removable disk drive, a hard disk drive, a direct access storage device (DASD), an optical drive (e.g., a CD drive, a DVD drive, etc.), a solid state storage drive (SSD), network attached storage, a storage area network, and/or a tape drive, among others.

Each processor illustrated in FIG. 1, as well as various additional controllers and subsystems disclosed herein, generally operates under the control of an operating system, and executes or otherwise relies upon various computer software applications, components, programs, objects, modules, data structures, etc., as will be described in greater detail below. Moreover, various applications, components, programs, objects, modules, etc. may also execute on one or more processors in another computer coupled to vehicle 10 via network, e.g., in a distributed, cloud-based, or client-server computing environment, whereby the processing required to implement the functions of a computer program may be allocated to multiple computers and/or services over a network. Further, in some implementations data recorded or collected by a vehicle may be manually retrieved and uploaded to another computer or service for analysis.

In general, the routines executed to implement the various implementations described herein, whether implemented as part of an operating system or a specific application, component, program, object, module, machine learning model, or sequence of instructions, or even a subset thereof, will be referred to herein as “program code.” Program code typically comprises one or more instructions that are resident at various times in various memory and storage devices, and that, when read and executed by one or more processors, perform the steps necessary to execute steps or elements embodying the various aspects of the invention. Moreover, while the invention has and hereinafter will be described in the context of fully functioning computers and systems, it will be appreciated that the various implementations described herein are capable of being distributed as a program product in a variety of forms, and that the invention applies equally regardless of the particular type of computer readable media used to actually carry out the distribution. Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.), among others.

In addition, various program code described hereinafter may be identified based upon the application within which it is implemented in a specific implementation. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein. In addition, while certain operations may be described herein as being performed in a particular order, this should not be understood as requiring that such operations be performed in the particular order described herein, or even in sequential order, or that all described operations be performed, to achieve desirable results. Multitasking, multithreading, and other parallel processing techniques may be used in some implementations, such that some operations may be performed concurrently, rather than sequentially.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

### Modular Adaptive Calibration Pipeline for Magnetic Navigation

As noted above, in order to navigate using the Earth's anomaly field, various platform effects associated with the vehicle upon which magnetic navigation is performed generally must be accounted for. Such platform effects may include, for example, magnetic signals created on the vehicle/platform, e.g., due to magnetic noise from onboard systems, as well as distortion in the Earth's magnetic field due to the magnetic characteristics of the vehicle itself and its orientation relative to the Earth's magnetic field. Conventional approaches to addressing these platform effects have generally relied on algorithms, and in some instances, mathematical models, that are highly platform-specific. Some conventional approaches, for example, have relied on creating a single artificial intelligence (AI) model that has been trained on data collected from a particular vehicle platform.

The use of a single platform-specific model, however, generally limits the use of the model to that particular platform, such that different models must be trained and deployed for different platforms. Furthermore, a platform-specific model may be incapable of effectively addressing any magnetic noise resulting from any changes to a platform that were not accounted for in the training data used to train that model, such that, for example, if new electronics are installed in a vehicle, any magnetic noise generated by those electronics will generally not be addressed by the model. In addition, systems aboard some platforms, such as lights, motors, communication equipment, etc., may turn on and off at non-deterministic intervals during travel, and while some of these sources and their characteristics can be known beforehand, others cannot, so adapting a single platform-specific model to account for such dynamic and non-deterministic variables can be difficult to achieve.

Another drawback of conventional approaches is a general lack of explainability as to the sources of magnetic noise, i.e., an understanding of what the sources of magnetic noise are on a particular platform, and in some instances, how those particular sources are addressed. On certain platforms, particularly aviation-related platforms, explainability as to the sources of magnetic noise on a platform may aid in the certification process, and may otherwise be useful in terms of identifying and potentially mitigating the effects of any magnetic noise sources altogether, e.g., such that the magnetic noise generated by a particular source is reduced or eliminated from the platform such that calibration or compensation is no longer needed to account for that particular source.

In implementations consistent with the invention, however, a modular adaptive approach may be used to calibrate or compensate for various platform effects, and in many cases, to do so in a substantially platform-independent manner that reduces or eliminates the amount of platform-specific training or customization required to implement in a specific vehicle platform. In particular, rather than using a single AI model to try to denoise sensors on a particular platform, the implementations described hereinafter utilize a modular adaptive calibration pipeline that approaches denoising from a more modular approach, in which a plurality of denoising modules, each having a specific and explainable objective, are employed in the pipeline to address different types of magnetic noise and other platform effects. The herein-described implementations enable modules to be created to respond to specific new noise sources in a platform and respond to changing platform dynamics, allowing the modules to respond in real-time, and without the need for large amounts of data to be acquired in order to adapt the module for a particular platform. As will become more apparent below, the modular/adaptive approach described herein allows for the natural change expected in platforms and makes the calibration process far more generalizable and efficient, and provides far greater explainability as to the potential sources of magnetic noise in a given platform.

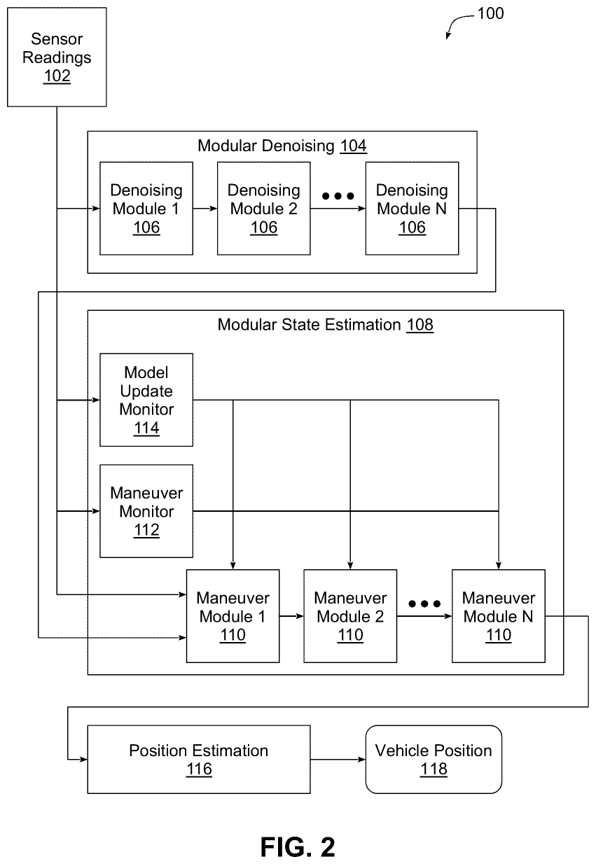

Now turning to FIG. 2, this figure illustrates an example implementation of a modular adaptive calibration pipeline 100 consistent with some implementations, and capable of being implemented, for example, in magnetic navigation system 12 of FIG. 1. As noted above, magnetic signal corruption can be broadly broken down into two categories: nearby noise sources (electronics, magnets, etc.) and platform orientation effects (i.e., the orientation of the platform in the earth's magnetic field and its corresponding effects on magnetometer readings). Addressing the former in pipeline 100 is referred to herein as denoising, while addressing the latter in pipeline 100 is referred to herein as state estimation.

As illustrated in FIG. 2, pipeline 100 receives various sensor readings 102, including at least one or more scalar and one or more vector magnetometers, but also potentially including data received from any of the other sensors described above. A modular denoising block 104 receives these sensor readings, and includes a plurality of specific, explainable denoising modules 106 (e.g., 1 . . . N denoising modules) that are focused on addressing various types of noise in the sensor readings. Sensor data may be selectively denoised in some or all of these blocks 106, as will become more apparent below, and passed to subsequent blocks for further processing. Modular denoising block 104 outputs denoised sensor data that has been denoised by one or more of denoising modules 106 and passes the denoised sensor data to a modular state estimation block 108, which includes a plurality of maneuver modules 110 (e.g., 1 . . . N maneuver modules) that are focused on calibrating the sensor data to address various states in which the vehicle may currently be in, effectively to correct for platform orientation effects associated with the vehicle's current orientation relative to the Earth's magnetic field. For example, the plurality of maneuver modules in some implementations may include an ascent module configured to calibrate for platform orientation effects while a vehicle is ascending, a descent module configured to calibrate for platform orientation effects while a vehicle is descending, a turning module configured to calibrate for platform orientation effects while a vehicle is turning, an evasion module configured to calibrate for platform orientation effects while a vehicle is undergoing evasive maneuvers, as well as other modules configured to calibrate for platform orientation effects associated with various types of maneuvers to which a vehicle may be subjected, e.g., acceleration, deceleration, touch and goes, air drops, docking/undocking, crash diving, hydrodynamic maneuvering, and/or “Crazy Ivan” maneuvers, among others.

Modular state estimation block 108 also includes a maneuver monitor 112 and a model update monitor 114. Maneuver monitor 112 may be used, for example, to determine what the current operational phase of the platform is, and activate the corresponding maneuver module 110 to calibrate the sensor data and thereby account for platform orientation effects. It will be appreciated, for example, that aircraft and other platforms have a variety of different operational regions such that, for example, an aircraft may climb during takeoff, descend while landing, or even potentially engage in various maneuvers such as evasive maneuvers, etc., and these various phases of operation can potentially require different or unique state estimation modules in order to properly calibrate the sensor data to account for platform orientation effects.

In some implementations, maneuver monitor 112 may incorporate a relatively straightforward logic based system that identifies flight state based on fixed thresholds, or in other implementations may incorporate a machine learning model, e.g., a neural network trained to identify states. In addition, over time, coefficients, weights, or other parameters in the maneuver modules 110 may change based on various physical/environmental factors, and model update monitor 114 may be used to issue triggers to maneuver modules 110 to determine when it is appropriate to update those parameters to optimize navigation performance.

Modular state estimation block 108 outputs calibrated sensor data to a position estimation block 116 that predicts and outputs a vehicle position 118, which may then be used by various of the aforementioned consumers for geolocation and/or navigation of the vehicle.

It will be appreciated that each denoising module 106 and each maneuver module 110, as well as each of monitors 112, 114, may receive processed sensor data from one or more upstream modules in the pipeline and/or raw sensor readings 102. Furthermore, different components 106, 110, 112, 114 may receive different types of sensor data, including raw sensor data from various sensors and/or sensor data that has previously been compensated for different platform effects by earlier stages of a pipeline. Thus, for example, while denoising modules 106 may predominantly receive and utilize magnetometer data (e.g., magnetic field data) in some implementations, the various components in modular state estimation block 108 may receive other types of sensor data, e.g., altimeter, barometer, gyroscope, and/or accelerometer data that may be useful in estimating the current state of the vehicle in some implementations. It will also be appreciated that the modules forming the various stages of pipeline 100 may be reordered in different implementations, and in some implementations, some modules may be omitted, additional modules may be used, and some modules may operate in parallel with one another.

In addition, in some implementations, modular denoising block 104 may pass noise correlation data to modular state estimation block 108. It will be appreciated, for example, that noise data across multiple sensors may be correlated with various state changes in a vehicle. In an aircraft, for example, a large spike in noise across multiple sensors may correlate with a landing gear, flap, or other noisy system engaging that indicates a new platform state has been entered. As another example, a continuation of correlated noise may indicate that the vehicle remains in the same state, and once the noise disappears, the vehicle has transitioned to a different state. As such, correlated noise may be used by modular state estimation block 108 in some implementations in connection with predicting the current state of the vehicle.

With further regard to modular denoising block 104, as noted above, this block may be implemented using a plurality of denoising modules 106 that are focused on addressing various types of noise in the sensor readings. Implementation of this block in some instances may incorporate one or more denoising monitors that monitor for different noise characteristics, e.g., different types of noise signals, in the sensor reading data streams, and upon detection of particular noise characteristics, activate specific noise removal modules to remove noise from the data streams and thereby address those particular noise signals.

A noise characteristic, in this regard, generally refers to a particular category of noise capable of being generated by a magnetic noise source or a particular category of magnetic noise sources that presents a noise signature that is capable of being detected in magnetic field data and is further capable of being removed from magnetic field data. It will be appreciated that a wide variety of noise characteristics may be detected and denoised in different implementations, and that such noise characteristics may vary for different types of platforms. Examples of noise characteristics that may be present in magnetic field data include, but are not limited to, periodic flashes associated with flashing lights on an aircraft, constant frequency tones associated with electronic line noise, variable frequency tones associated with engine speed, and time varying magnetic offsets associated with systems turning on and/or off, among others.

A denoising module, in some implementations, may include a monitor that is capable of detecting a noise characteristic in sensor data, and in response to detecting the noise characteristic, selectively activate at least one of set of noise removal modules. The set of noise removal modules may be considered to define a denoising pipeline, in which sensor data such as magnetic field data is passed along the pipeline, and where each activated noise removal module processes the magnetic field data to remove noise from the magnetic field data and thereby generate denoised magnetic field data. In some implementations, only one of the set of noise removal modules may be selectively activated at a time, while in other implementations, multiple noise removal modules may be selectively activated at a time, such that, at least for some noise removal modules, the magnetic field data that is received and denoised by the noise removal module is magnetic field data that has already been denoised by another noise removal module, rather than raw magnetic field data output by a magnetometer. Further, as noted above, multiple denoising modules 106 may be used such that multiple monitors monitor the sensor data for different noise characteristics, and the denoising pipeline incorporates noise removal modules capable of addressing different noise characteristics.

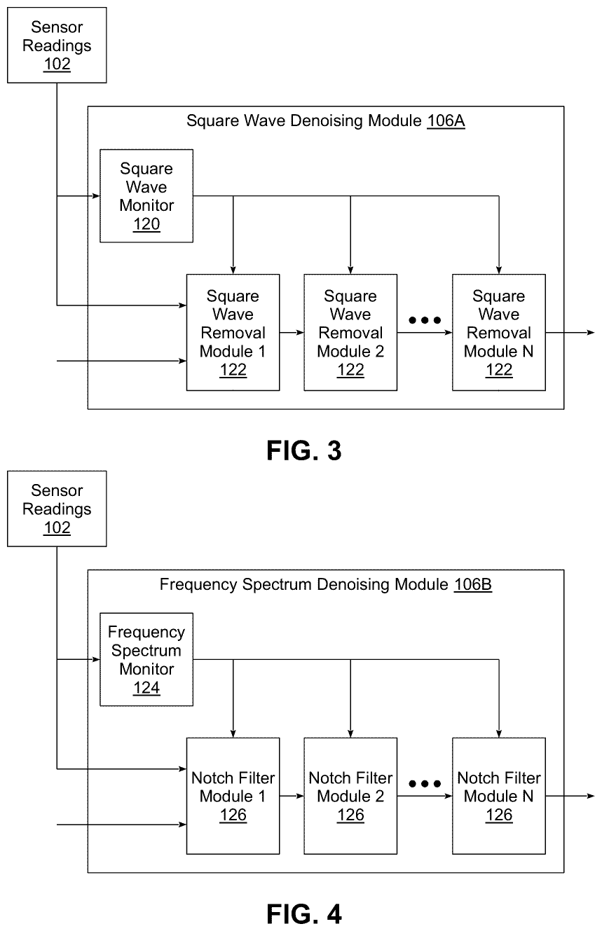

FIG. 3, for example, illustrates one type of denoising module, a square wave denoising module 106A, which may be used to look for and address noise characteristics associated with square wave noise sources (e.g., systems that are turned on/off that result in a square wave characteristic in the sensor measurements). A square wave monitor 120, for example, may be used to look for square wave noise signals in the sensor reading data streams and selectively activate one or more of a plurality of square wave removal modules 122 (e.g., 1 . . . N square wave removal modules) to address the specific square wave signals detected in the data streams. For example, in one illustrative platform, there could be a strobe light that cycles on and off in 1 second intervals, as well as a printed circuit board near a magnetometer that is cycling at 100 Hz. Monitor 120 may be configured to identify these signals, and various square wave removal modules 122 may be configured to remove square waves at different frequencies or frequency ranges, such that, upon detecting any of the aforementioned square waves, monitor 120 may enable corresponding square wave modules 122 to remove them.

FIG. 4 illustrates another type of denoising module, a frequency spectrum denoising module 106B, which includes a frequency spectrum monitor 124 that analyzes the frequency spectrums of the sensor reading data streams to identify noise characteristics of particular noise sources at different frequencies or in different frequency ranges and selectively activates one or more of a plurality of notch filter modules 126 (e.g., 1 . . . N notch filter modules) to filter out noise sources in the magnetic field data at a predetermined frequency or within a predetermined frequency range. Monitor 124, for example, may generate a frequency power spectrum and identify peaks in the frequency power spectrum, and activate one or more notch filter modules to attenuate the peaks in the frequency power spectrum.

It will be appreciated that other types of denoising modules may be used in other implementations to detect and compensate for various types of noise sources, e.g., sinusoidal wave detectors/filters, high pass filters, low pass filters, bandpass filters, DC offset removal modules, Tolles-Lawson compensation, etc. It will be appreciated that the types of noise that may affect sensor readings may vary considerably for different platforms and vehicles; however, so long as the noise is capable of being detected and compensated for in the sensor readings, a suitable denoising module may generally be developed to account for such noise.

Thus, by combining a plurality of different types of denoising modules in pipeline 100, the pipeline allows for a modular, explainable, and adaptive denoising process. Moreover, it will be appreciated that if a system is well understood (for example, a UAV or drone where no new noise sources are expected), then the pipeline may include a sequence of fixed modules that are tuned to the well understood and characterized noise sources on the platform, such that the use of monitors to selectively activate different modules may not be required. It will also be appreciated that activation or deactivation of a denoising module by a monitor may be implemented in various manners in different implementations. For example, in a dynamic pipeline implementation, denoising modules may be dynamically created and added to a pipeline when noise is detected (and correspondingly dynamically removed and destroyed when noise is no longer detected), while in a static pipeline implementation, all activatable denoising modules may be provided in a pipeline and selectively enabled/disabled (or bypassed) based upon the types of detected noise.

Each of the various modules and monitors utilized in connection with modular denoising block 104 and/or modular state estimation block 108 of pipeline 100 of FIG. 2 may be implemented in a wide variety of different manners based upon factors such as type of platform effect being addressed, processing bandwidth, etc. Moreover, each module and/or monitor may be implemented using various techniques, e.g., machine learning models, linear models, physics-based models, algorithmic approaches, etc., and may be implemented fully in software, fully in hardware (e.g., using dedicated hardware logic such as DSPs, FPGAs, dedicated passive and/or active circuitry and the like) and/or using a combination of software and hardware in different implementations. Filter-based noise removal modules such as square wave removal modules 122 and notch filter modules 126, for example, may utilize hardware and/or software filters for denoising, and various monitors may utilize program logic to detect noise, detect a vehicle's current state and/or determine when modules require updating.

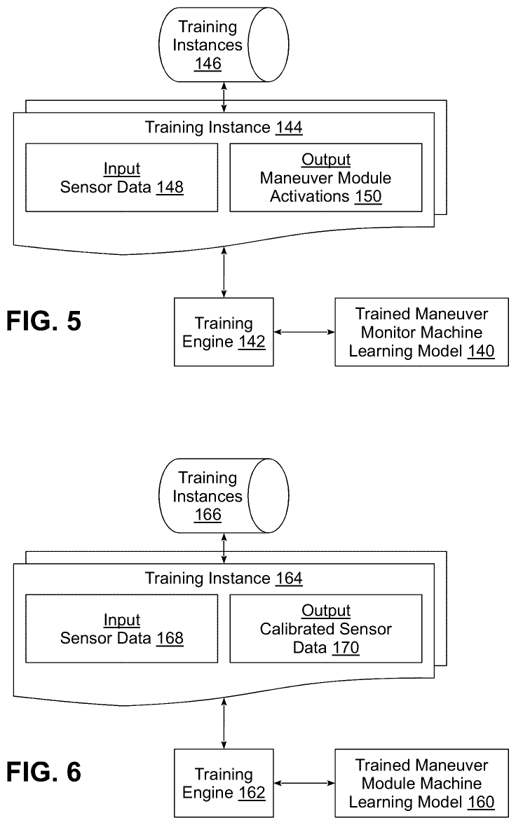

In some implementations, however, it may be desirable to implement many of the modules and monitors using machine learning models that are trained to detect noise characteristics, detect a vehicle's current state, denoise sensor data, calibrate for different platform states, etc. FIGS. 5-10, for example, illustrate various machine learning models suitable for implementing various modules and monitors from pipeline 100, as well as the training systems and training instances utilized to train these models for their particular functions.

In some implementations, each model may be implemented as a deep neural network (DNN) including an input layer, one or more intermediate layers, and an output layer, which in some implementations may include multiple output heads. In some implementations, for example, one or more intermediate layers may include one or more convolutional layers. The dimensions/shape of the input layer may be dependent on the shape of the sensor data to be applied, while the dimensions/shape of each output head may be dependent on various factors such as how many class probabilities are to be predicted, the format of the denoised and/or calibrated sensor data to be output, etc. In some implementations, multiple convolution layers may be provided, and max pooling and/or other layers such as affine layers, softmax layers and/or fully connected layers may optionally be interposed between one or more of the convolution layers and/or between a convolution layer and the output layer. Other implementations may not include any convolution layer and/or not include any max pooling layers, and in still other implementations, other machine learning models may be used, e.g., Bayesian models, random forest models, Markov models, etc.

Furthermore, training of any of the models discussed herein may be based on platform-specific and/or platform-independent training data. It will be appreciated that in conventional approaches utilizing a single machine learning model to address all platform effects is generally highly platform-specific, such that training of such a model is performed using training data collected for the specific platform for which the machine learning model will ultimately be used. However, using the modular adaptive approach described herein, training of individual models used in such an approach may, in some implementations, predominantly utilize platform-independent training data since denoising and/or calibration for platform orientation effects is generally applied dynamically based on detected noise and/or vehicle states that are generally not tied to one specific platform. Such an approach also allows individual models to be utilized for different vehicles and platforms, and generally with little or no platform-specific training, which can substantially reduce the cost and effort required to implement a modular adaptive magnetic navigation system for use on a particular platform.

FIG. 5 illustrates an example system for training a maneuver monitor machine learning model 140, which may be used, for example, to implement maneuver module 112 of FIG. 2 in some implementations. A training engine 142 may utilize platform-specific and/or platform-independent training instances 144 retrieved from a training instances database 146. The input 148 of each training instance, for example, may include sensor data such as vector and/or scalar accelerometer data, altimeter data, barometer data, accelerometer data, gyroscope data, as well as any other data that may be useful for determining a vehicle's current state such as tachometer data, magnetic compass data, airspeed indicator data, etc., and the output 150 of each training instance may include activation classifications for various maneuver modules. In some implementations, for example, the training instance output 150 may define, for each of a plurality of maneuver modules, whether that module should or should not be activated given the vehicle state represented by the input data. In training model 140, training engine 142 may apply the training instance input 148 to model 140 and process the training instance input 148, utilizing model 140 and based on current parameters of model 140, to generate an output having a dimension that conforms to the dimension of training instance output 150. Training engine 142 may then compare the generated output to the training instance output 150, and update one or more parameters of model 140 based on the comparison. For example, training engine 142 may generate an error based on differences between the generated output and the training instance output 150, and backpropagate a loss (that is based on the error) over model 140 to update model 140. Although only a single training instance 144 is illustrated in FIG. 5, model 140 will generally be trained based on a large quantity of training instances of training instances database 146. Those training instances can collectively include training instance inputs with diverse sensor data and diverse training instance outputs. Moreover, although non-batch training is described with respect to FIG. 5, batch training may additionally or alternatively be utilized (e.g., where losses are based on errors determined based on a batch of training instances).

FIG. 6 similarly illustrates an example system for training a maneuver module machine learning model 160, which may be used, for example, to implement maneuver module 110 of FIG. 2 in some implementations. A training engine 162 may utilize platform-specific and/or platform-independent training instances 164 retrieved from a training instances database 166. The input 168 of each training instance, for example, may include sensor data such as vector and/or scalar accelerometer data, altimeter data, barometer data, accelerometer data, gyroscope data, as well as any other data that may be useful for calibrating magnetic field data collected from the magnetometers based upon a vehicle's current state such as tachometer data, magnetic compass data, airspeed indicator data, etc., and the output 170 of each training instance may include calibrated magnetic field data correlated to the input magnetic field data.

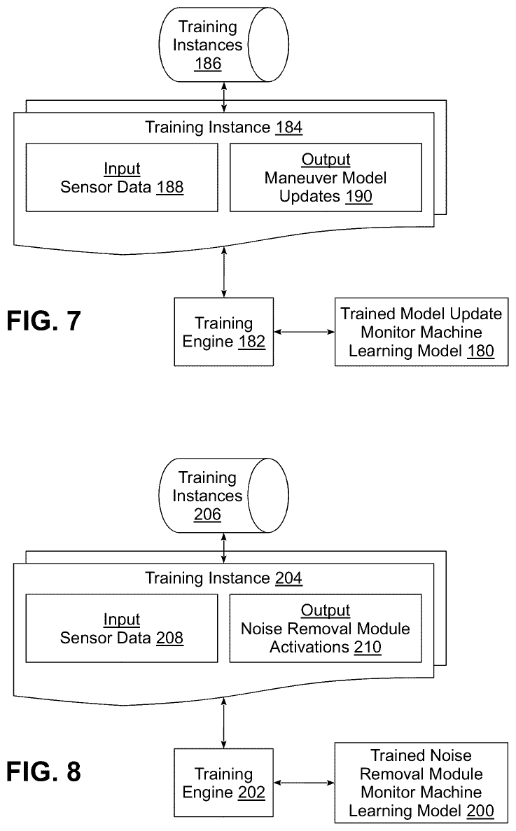

FIG. 7 similarly illustrates an example system for training a model update monitor machine learning model 180, which may be used, for example, to implement model update monitor 114 of FIG. 2 in some implementations. A training engine 182 may utilize platform-specific and/or platform-independent training instances 184 retrieved from a training instances database 186. The input 188 of each training instance, for example, may include sensor data such as vector and/or scalar accelerometer data, altimeter data, barometer data, accelerometer data, gyroscope data, as well as any other data that may be useful for determining whether a maneuver module needs to be updated such as tachometer data, magnetic compass data, airspeed indicator data, etc., and the output 190 of each training instance may include update classifications for various maneuver modules. In some implementations, for example, the training instance output 190 may define, for each of a plurality of maneuver modules, whether that module should or should not be triggered for an update.

FIG. 8 illustrates an example system for training a noise removal module monitor machine learning model 200, which may be used, for example, to implement various monitors used in modular denoising block 104 of FIG. 2 in some implementations, e.g., monitors 120 and/or 124 of FIGS. 3-4. A training engine 202 may utilize platform-specific and/or platform-independent training instances 204 retrieved from a training instances database 206. The input 208 of each training instance, for example, may include sensor data such as vector and/or scalar accelerometer data, altimeter data, barometer data, accelerometer data, gyroscope data, as well as any other data that may be useful for detecting a particular type of magnetic noise such as tachometer data, magnetic compass data, airspeed indicator data, etc., and the output 210 of each training instance may include activation classifications for various noise removal modules. In some implementations, for example, the training instance output 210 may define, for each of a plurality of noise removal modules, whether that module should or should not be activated given the type and/or magnitude of noise detected in the input data.

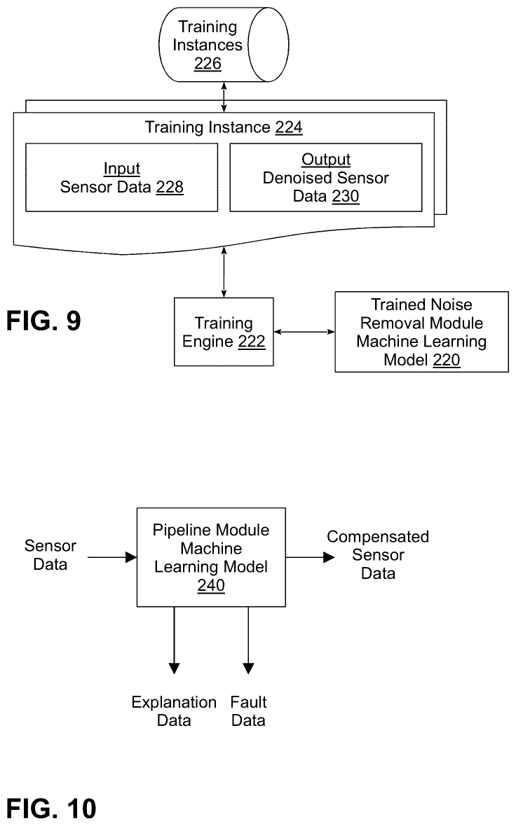

FIG. 9 illustrates an example system for training a noise removal module machine learning model 220, which may be used, for example, to implement any of the various noise removal modules discussed herein, e.g., modules 122 and 126 of FIGS. 3-4, in some implementations. A training engine 222 may utilize platform-specific and/or platform-independent training instances 224 retrieved from a training instances database 226. The input 228 of each training instance, for example, may include sensor data such as vector and/or scalar accelerometer data, altimeter data, barometer data, accelerometer data, gyroscope data, as well as any other data that may be useful for denoising magnetic field data collected from the magnetometers based upon detected noise such as tachometer data, magnetic compass data, airspeed indicator data, etc., and the output 230 of each training instance may include denoised magnetic field data correlated to the input magnetic field data.

Next, turning to FIG. 10, as noted above, in some implementations a machine learning model may be implemented as a multi-head model that incorporates multiple output heads for generating multiple outputs based on input sensor data. Model 240, for example, is a pipeline module machine learning model capable of denoising or calibrating sensor data, and as such, includes an output that generates compensated sensor data (e.g., denoised and/or calibrated sensor data) based on input sensor data, which in some implementations may be raw sensor data and/or sensor data that has previously been compensated for different platform effects by earlier stages of a pipeline. In addition, however, model 240 may also generate one or more additional outputs. For example, it may be desirable to incorporate an output that generates explanation data, which assists in explaining what noise and/or platform effect was processed by the model and how it was processed. In addition, it may be desirable to incorporate an output that generates fault data, e.g., to generate a notification when some noise or platform effect was incapable of being suitably compensated for. It will be appreciated that similar explanation data and/or fault data may also be output by a monitor model with respect to the activation/deactivation of different noise removal or maneuver modules, in addition to module activation data that activates/deactivates different noise removal or maneuver modules. Furthermore, it will be appreciated that such output data may be used for various purposes, e.g., certification, fault detection and recovery, and other purposes that will be apparent to one of ordinary skill in the art having the benefit of the instant disclosure.

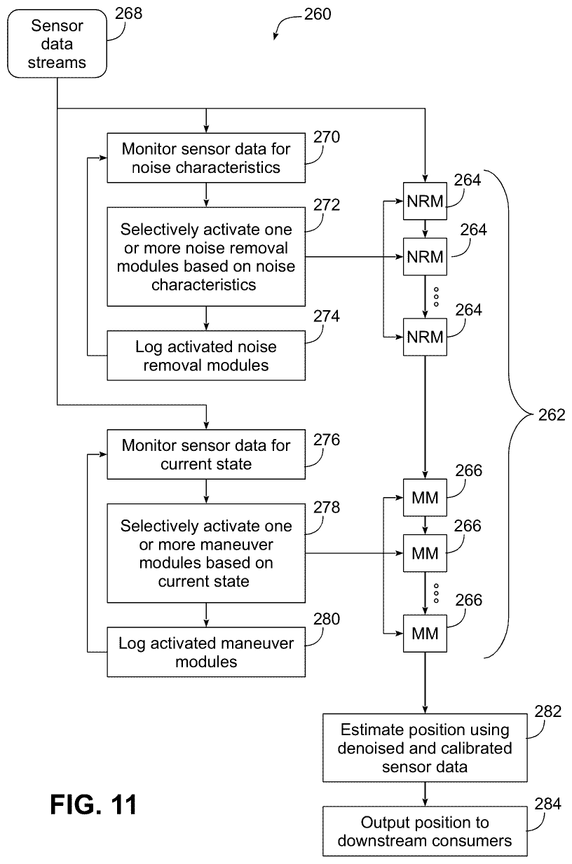

FIG. 11 next illustrates an example operational sequence 260 for operating a modular adaptive magnetic navigation system consistent with some implementations. Operational sequence 260 controls a pipeline 262 including a plurality of noise removal modules 264 and a plurality of maneuver modules 266, and based on a plurality of sensor data streams 268 supplied by a plurality of sensors of a vehicle. Sensor data streams are supplied to pipeline 262 and passed from module 264, 266 to module 264, 266, with some sensor data streams denoised and/or calibrated by selected activated modules 264, 266. Blocks 270, 272, and 274 implement one or more denoising monitors to monitor the sensor data streams for specific noise characteristics (block 270), and in response to detecting certain noise characteristics, selectively activating one or more noise removal modules 264 to denoise the sensor data and thereby address the detected noise characteristics (block 272). In addition, in some implementations, the activation/deactivation states of various noise removal modules may be logged in block 274 to provide explainability as to the types of noise being detected in the sensor data.

Similarly, blocks 276, 278, and 280 implement one or more maneuver monitors to monitor the sensor data streams to detect the current state of the vehicle with respect to platform orientation effects (block 276). In various implementations, the current state may include an identification of one or more maneuvers that a vehicle is currently undergoing, although other data may be used to represent a current state in addition to or in lieu of identified maneuvers, e.g., position, velocity, heading, acceleration/deceleration, pitch, yaw, roll, activation/deactivation/current positions/current states of various vehicle components, etc. Based on the detected current state, one or more maneuver modules are activated in block 278. In addition, in some implementations, the activation/deactivation states of various maneuver modules may be logged in block 280 to provide explainability as to the current state of the vehicle over time and the platform orientation effects associated therewith.

The output of pipeline 266 is one or more data streams of denoised and calibrated sensor data, including in particular denoised and calibrated magnetic field data, which is then passed to block 282 to estimate the vehicle's current position, in a manner that will be apparent to those of ordinary skill in the art having the benefit of the instant disclosure. Specifically, in some implementations, the denoised and calibrated magnetic field data may be compared with reference magnetic field data (e.g., magnetic anomaly map data), and optionally further based on position estimates generated by other navigation system such as GPS and inertial navigation system, in order to generate an estimated position (and in some instances, an orientation and/or velocity) of the vehicle. The position is then output to downstream consumers (e.g., user interfaces, vehicle control systems, etc.) in block 284.

It will be appreciated that, while certain features may be discussed herein in connection with certain implementations and/or in connection with certain figures, unless expressly stated to the contrary, such features generally may be incorporated into any of the implementations discussed and illustrated herein. Moreover, features that are disclosed as being combined in some implementations may generally be implemented separately in other implementations, and features that are disclosed as being implemented separately in some implementations may be combined in other implementations, so the fact that a particular feature is discussed in the context of one implementation but not another should not be construed as an admission that those two implementations are mutually exclusive of one another. Other variations will be apparent to those of ordinary skill. Therefore, the invention lies in the claims hereinafter appended.

1. A computer-implemented method of magnetic navigation, comprising:
receiving sensor data, the sensor data including magnetic field data collected from one or more magnetometers of a vehicle;
in a first monitor, detecting a noise characteristic in the received sensor data, and in response to detecting the noise characteristic, selectively activating at least one of a plurality of noise removal modules in a denoising pipeline;
in each selectively activated noise removal module in the denoising pipeline, removing noise associated with the detected noise characteristic from the magnetic field data;
in a second monitor, detecting a current state of the vehicle from the received sensor data, and in response to detecting the current state of the vehicle, selectively activating at least one of a plurality of maneuver modules in a state calibration pipeline;
in each selectively activated maneuver module in the state calibration pipeline, calibrating the magnetic field data to correct for platform orientation effects, wherein removing noise associated with the detected noise characteristic and calibrating the magnetic field data to correct for platform orientation effects generates denoised and calibrated magnetic field data from the received sensor data; and
estimating a position of the vehicle using the denoised and calibrated magnetic field data.

2. The method of claim 1, wherein estimating the position of the vehicle includes comparing the denoised and calibrated magnetic field data to reference magnetic field data from a magnetic anomaly map.

3. The method of claim 1, wherein the first monitor comprises a square wave denoising monitor configured to detect a square wave noise signal in the received sensor data, and the plurality of noise removal modules includes a plurality of square wave denoising modules, each of the plurality of square wave denoising modules is configured to remove square wave noise signals from the magnetic field at a predetermined frequency or within a predetermined frequency range.

4. The method of claim 1, wherein the first monitor comprises a frequency spectrum denoising monitor configured to analyze a frequency spectrum from the received sensor data to identify a noise source in the magnetic field data, and the plurality of noise removal modules includes a plurality of notch filter modules, each of the plurality of notch filter modules is configured to filter out noise sources in the magnetic field data at a predetermined frequency or within a predetermined frequency range.

5. The method of claim 1, wherein the plurality of noise removal modules includes a sinusoidal wave filter module, a high pass filter module, a low pass filter module, a bandpass filter module, a DC offset removal module and/or a Tolles-Lawson module.

6. The method of claim 1, wherein the noise characteristic includes a square wave, a frequency spectrum peak, a sinusoidal wave, or a DC offset.

7. The method of claim 1, wherein the noise characteristic is a first noise characteristic and the plurality of noise removal modules is a first plurality of noise removal modules, the method further comprising:
in a third monitor, detecting a second noise characteristic in the received sensor data, and in response to detecting the second noise characteristic, selectively activating at least one of a second plurality of noise removal modules in the denoising pipeline; and
in each selectively activated noise removal module in the second plurality of noise removal modules in the denoising pipeline, removing noise associated with the second detected noise characteristic from the magnetic field data.

8. The method of claim 1, wherein the second monitor comprises a maneuver monitor.

9. The method of claim 1, wherein the plurality of maneuver modules includes an ascent module configured to calibrate for platform orientation effects while the vehicle is ascending, a descent module configured to calibrate for platform orientation effects while the vehicle is descending, a turning module configured to calibrate for platform orientation effects while the vehicle is turning, and/or an evasion module configured to calibrate for platform orientation effects while the vehicle is undergoing evasive maneuvers.

10. The method of claim 1, wherein at least a subset of the plurality of maneuver modules include machine learning models, and the method further comprises, in a model update monitor, triggering an update of at least one of plurality of maneuver modules.

11. The method of claim 10, wherein the model update monitor includes a machine learning model configured to output update classifications for the plurality of maneuver modules, and the machine learning module is trained using a plurality of training instances mapping sensor data to updated maneuver modules.

12. The method of claim 1, wherein the sensor data further includes altimeter data, barometer data, accelerometer data, tachometer data, magnetic compass data, airspeed indicator data, and/or gyroscope data.

13. The method of claim 1, wherein the first monitor includes a machine learning model configured to output activation classifications for the plurality of noise removal modules, and the machine learning module is trained using a plurality of training instances mapping sensor data to activated noise removal modules.

14. The method of claim 1, wherein the second monitor includes a machine learning model configured to output activation classifications for the plurality of maneuver modules, and the machine learning module is trained using a plurality of training instances mapping sensor data to activated maneuver modules.

15. The method of claim 1, wherein a first noise removal module of the plurality of noise removal modules includes a machine learning model configured to denoise magnetic field data from the received sensor data, and the machine learning module is trained using a plurality of training instances mapping sensor data to denoised magnetic field data.

16. The method of claim 1, wherein a first maneuver module of the plurality of maneuver modules includes a machine learning model configured to calibrate the magnetic field data to correct for platform orientation effects, and the machine learning module is trained using a plurality of training instances mapping sensor data to calibrated magnetic field data.

17. The method of claim 1, wherein at least one of the first monitor, the second monitor, a first noise removal module of the plurality of noise removal modules, and a first maneuver module of the plurality of noise removal modules includes a machine learning model, and the machine learning module is trained using a plurality of platform-independent training instances.

18. The method of claim 17, wherein the machine learning model is further trained using a plurality of platform-specific training instances.

19. The method of claim 1, wherein at least one of the first monitor, the second monitor, a first noise removal module of the plurality of noise removal modules, and a first maneuver module of the plurality of noise removal modules includes a machine learning model, and the machine learning model outputs explanation and/or fault data in addition to compensated sensor data and/or module activation data.

20. A magnetic navigation system comprising one or more processors and memory operably coupled with the one or more processors, wherein the memory stores instructions that, in response to execution of the instructions by one or more processors, cause the one or more processors to perform a method of magnetic navigation that includes:
receiving sensor data, the sensor data including magnetic field data collected from one or more magnetometers of a vehicle;
in a first monitor, detecting a noise characteristic in the received sensor data, and in response to detecting the noise characteristic, selectively activating at least one of a plurality of noise removal modules in a denoising pipeline;
in each selectively activated noise removal module in the denoising pipeline, removing noise associated with the detected noise characteristic from the magnetic field data;
in a second monitor, detecting a current state of the vehicle from the received sensor data, and in response to detecting the current state of the vehicle, selectively activating at least one of a plurality of maneuver modules in a state calibration pipeline;
in each selectively activated maneuver module in the state calibration pipeline, calibrating the magnetic field data to correct for platform orientation effects, wherein removing noise associated with the detected noise characteristic and calibrating the magnetic field data to correct for platform orientation effects generates denoised and calibrated magnetic field data from the received sensor data; and
estimating a position of the vehicle using the denoised and calibrated magnetic field data.

21. A non-transitory computer readable storage medium storing computer instructions executable by one or more processors to perform a method of magnetic navigation that includes:
receiving sensor data, the sensor data including magnetic field data collected from one or more magnetometers of a vehicle;
in a first monitor, detecting a noise characteristic in the received sensor data, and in response to detecting the noise characteristic, selectively activating at least one of a plurality of noise removal modules in a denoising pipeline;
in each selectively activated noise removal module in the denoising pipeline, removing noise associated with the detected noise characteristic from the magnetic field data;
in a second monitor, detecting a current state of the vehicle from the received sensor data, and in response to detecting the current state of the vehicle, selectively activating at least one of a plurality of maneuver modules in a state calibration pipeline;
in each selectively activated maneuver module in the state calibration pipeline, calibrating the magnetic field data to correct for platform orientation effects, wherein removing noise associated with the detected noise characteristic and calibrating the magnetic field data to correct for platform orientation effects generates denoised and calibrated magnetic field data from the received sensor data; and
estimating a position of the vehicle using the denoised and calibrated magnetic field data.

22. (canceled)

23. (canceled)
